(19) United States
(12) Patent Application Publication
(10) Pub. No.: US 2023/0201774 A1
(43) Pub. Date: Jun. 29, 2023

(54) System For Capturing Carbon From Air Based On Bipolar Membrane Electrodialysis

(71) Applicant: Tianjin University, Tianjin (CN)

(72) Inventors: Shuai DENG, Tianjin (CN); Peng SUN, Tianjin (CN); Yaowei HUANG, Tianjin (CN)

(21) Appl. No.: 17/716,017

(22) Filed: Apr. 8, 2022

(30) Foreign Application Priority Data
Dec. 29, 2021 (CN) 202111638330.X

(51) Int. Cl. B01D 61/46; B01D 61/44; B01D 53/32; B01D 53/62

(52) U.S. Cl. CPC B01D 61/46; B01D 61/445; B01D 53/326; B01D 53/62; B01D 2251/606; B01D 2251/306; B01D 2257/504; B01D 2258/06

(57) ABSTRACT

The present disclosure provides a system for capturing carbon from air based on bipolar membrane electrodialysis, which includes a first cation exchange membrane, a bipolar membrane and a second cation exchange membrane arranged in sequence, where a desorption chamber is arranged between the first cation exchange membrane and the bipolar membrane, and an absorption chamber is arranged between the bipolar membrane and the second cation exchange membrane; and a cathode reaction chamber is arranged on the other side of the first cation exchange membrane, and an anode reaction chamber is arranged on the other side of the second cation exchange membrane. The system improves carbon capture rate and capture purity, and can be adapted to various scenarios.

### CROSS REFERENCE TO RELATED APPLICATION

This patent application claims the benefit and priority of Chinese Patent Application No. 202111638330.X, entitled “System for capturing carbon from air based on bipolar membrane electrodialysis” filed on Dec. 29, 2021, the disclosure of which is incorporated by reference herein in its entirety as part of the present application.

### TECHNICAL FIELD

The present disclosure relates to the technical field of carbon capture, and in particular to a system for capturing carbon from air based on bipolar membrane electrodialysis.

### BACKGROUND ART

In recent years, the massive burning of fossil fuels has increased the concentration of carbon dioxide (CO₂) in the air, resulting in an increasingly serious greenhouse effect. With the increasing demand for energy, fossil fuels will remain a main energy source for decades to come. Although traditional carbon capture models, such as post-combustion capture from large point sources, can slow down the rise in an atmospheric CO₂ concentration, the technology of direct CO₂ capture from air, as a representative of negative carbon technologies, can “intervene” the atmospheric CO₂ concentration more directly, providing another guarantee for the smooth realization of carbon neutrality. Existing technologies for capturing carbon from air include solution absorption, solid adsorption and electrodialysis.

Although the above methods have a relatively simple process and low cost, they have a relatively low carbon capture rate and relatively low capture purity, making it difficult to fully lower the high CO₂ concentration in the air.

### SUMMARY

In view of this, the present disclosure provides a system for capturing carbon from air based on bipolar membrane electrodialysis. The system improves carbon capture rate and capture purity, and can be adapted to various scenarios.

In order to achieve the above objective, the present disclosure provides the following technical solutions:
a system for capturing carbon from air based on bipolar membrane electrodialysis, including a first cation exchange membrane, a bipolar membrane and a second cation exchange membrane arranged in sequence;
wherein a desorption chamber is arranged between the first cation exchange membrane and the bipolar membrane, and an absorption chamber is arranged between the bipolar membrane and the second cation exchange membrane; and
a cathode reaction chamber is arranged on the other side of the first cation exchange membrane, and an anode reaction chamber is arranged on the other side of the second cation exchange membrane.

In some embodiments, one end of the desorption chamber and one end of the absorption chamber are connected by a first pipeline;
the other end of the desorption chamber and the other end of the absorption chamber are connected by a second pipeline; and
a bicarbonate solution is passed into the desorption chamber and the absorption chamber, respectively.

In some embodiments, one end of the cathode reaction chamber and one end of the anode reaction chamber are connected by a third pipeline;
the other end of the cathode reaction chamber and the other end of the anode reaction chamber are connected by a fourth pipeline;
a to-be-reduced solution is passed into the cathode reaction chamber, and a to-be-oxidized solution is passed into the anode reaction chamber; and
the to-be-reduced solution and the to-be-oxidized solution form a redox pair.

In some embodiments, the system further includes a first electrode, a second electrode and a power source;
the first electrode is arranged in the cathode reaction chamber and connected to a negative electrode of the power source; and
the second electrode is arranged in the anode reaction chamber and connected to a positive electrode of the power source.

In some embodiments, the bipolar membrane includes a cation exchange layer, a reaction layer and an anion exchange layer connected in sequence.

In some embodiments, the bipolar membrane is any one selected from the group consisting of a BP-1 bipolar membrane and an FBM bipolar membrane.

In some embodiments, the bicarbonate solution is a KHCO₃ solution.

In some embodiments, the to-be-reduced solution is a K₃[Fe(CN)₆] solution, and the to-be-oxidized solution is a K₄[Fe(CN)₆] solution.

In some embodiments, the first electrode and the second electrode are each any one selected from the group consisting of Pt, Au, Pd, Ru, Ir, Rh, Re, Os, Cu, Ag, Fe, Co, Ni, Zn and C or a combination thereof.

According to the embodiments provided in the present disclosure, the present disclosure discloses the following technical effects.

The present disclosure provides a system for capturing carbon from air based on bipolar membrane electrodialysis, which includes a first cation exchange membrane, a bipolar membrane and a second cation exchange membrane arranged in sequence, wherein a desorption chamber is arranged between the first cation exchange membrane and the bipolar membrane, and an absorption chamber is arranged between the bipolar membrane and the second cation exchange membrane; and a cathode reaction chamber is arranged on the other side of the first cation exchange membrane, and an anode reaction chamber is arranged on the other side of the second cation exchange membrane. The system improves carbon capture rate and capture purity, and can be adapted to various scenarios.

### BRIEF DESCRIPTION OF THE DRAWINGS

In order to describe the technical schemes in the embodiments of the present disclosure or in prior art more clearly, the drawings needed to be used in the description of the examples will be introduced below. Obviously, the drawings in the following description are only examples of the present disclosure, and those ordinary skilled in the art may still obtain other drawings based on the provided drawings without creative work.

FIG. 1 shows a structural schematic diagram of the system for capturing carbon from air based on bipolar membrane electrodialysis according to the present disclosure.

Reference number: 1—first cation exchange membrane, 2—bipolar membrane, 3—second cation exchange membrane, 4—desorption chamber, 5—absorption chamber, 6—first electrode, 7—second electrode, 8—power source, 9—first pipeline, 10—second pipeline, 11—third pipeline, 12—fourth pipeline, 13—cathode reaction chamber, and 14—anode reaction chamber.

### DETAILED DESCRIPTION OF THE EMBODIMENTS

The technical solutions in the examples of the present disclosure will be clearly and completely described below with reference to the drawings in the examples of the present disclosure. Obviously, the described examples are only a part of rather than all of the examples. Based on the examples of the present disclosure, all other examples obtained by those ordinary skilled in the art without creative work shall fall within the protection scope of the present disclosure.

An object of the present disclosure is to provide a system for capturing carbon from air based on bipolar membrane electrodialysis. The system improves carbon capture rate and capture purity, and can be adapted to various scenarios.

In order to make the above-mentioned objective, features and advantages of the present disclosure more clearly and easier to be understood, the present disclosure will be described in further detail below with reference with drawings and specific embodiments.

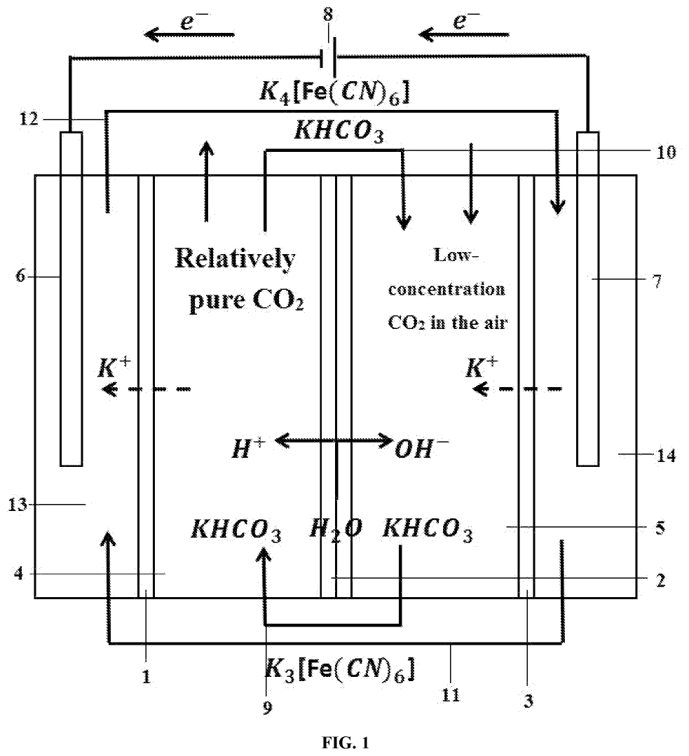

FIG. 1 shows a structural schematic diagram of the system for capturing carbon from air based on bipolar membrane electrodialysis according to the present disclosure. As shown in the figure, the present disclosure provides a system for capturing carbon from air based on bipolar membrane electrodialysis, which includes a first cation exchange membrane 1, a bipolar membrane 2 and a second cation exchange membrane 3 arranged in sequence.

The bipolar membrane 2 includes a cation exchange layer, a reaction layer and an anion exchange layer connected in sequence. In this example, the bipolar membrane 2 was any one selected from the group consisting of a BP-1 bipolar membrane and an FBM bipolar membrane.

A desorption chamber 4 was arranged between the first cation exchange membrane 1 and the bipolar membrane 2, and an absorption chamber 5 was arranged between the bipolar membrane 2 and the second cation exchange membrane 3.

A cathode reaction chamber 13 was arranged on the other side of the first cation exchange membrane 1, and an anode reaction chamber 14 was arranged on the other side of the second cation exchange membrane 3.

Further, one end of the desorption chamber 4 and one end of the absorption chamber 5 were connected by a first pipeline 9.

The other end of the desorption chamber 4 and the other end of the absorption chamber 5 were connected by a second pipeline 10.

A bicarbonate solution was passed into the desorption chamber 4 and the absorption chamber 5, respectively. In this example, the bicarbonate solution was a KHCO₃ solution.

In some embodiments, the system further includes a first electrode 6, a second electrode 7 and a power source 8.

The first electrode 6 was arranged in the cathode reaction chamber 13 and connected to a negative electrode of the power source 8.

The second electrode 7 was arranged in the anode reaction chamber 14 and connected to a positive electrode of the power source 8.

In this example, the first electrode 6 and the second electrode 7 were each any one selected from the group consisting of Pt, Au, Pd, Ru, Ir, Rh, Re, Os, Cu, Ag, Fe, Co, Ni, Zn and C or a combination thereof.

Further, one end of the cathode reaction chamber 13 and one end of the anode reaction chamber 14 were connected by a third pipeline 11. The other end of the cathode reaction chamber 13 and the other end of the anode reaction chamber 14 were connected by a fourth pipeline 12.

A to-be-reduced solution was passed into the cathode reaction chamber 13, and a to-be-oxidized solution was passed into the anode reaction chamber 14. In this example, the to-be-reduced solution was a K₃[Fe(CN)₆] solution, and the to-be-oxidized solution was a K₄[Fe(CN)₆] solution.

The to-be-reduced solution and the to-be-oxidized solution formed a redox pair.

The main reactions involved in the present disclosure are as follows:
the reaction in the absorption chamber 5: OH⁻+CO₂(aq)↔HCO₃⁻; where aq represents an aqueous solution;
the reactions in the desorption chamber 4: HCO₃⁻+H⁺↔CO₂(aq)+H₂O; CO₂(aq)↔CO₂(g); where g represents a gaseous state;
the reaction in the bipolar membrane 2: H₂O↔H⁺+OH⁻;
the reaction in the anode reaction chamber 14: [Fe(CN)₆]⁴⁻−e⁻→[Fe(CN)₆]³⁻; and
the reaction in the cathode reaction chamber 13: [Fe(CN)₆]³⁻+e⁻→[Fe(CN)₆]⁴⁻.

Specifically, the principle of the present disclosure is as follows:

The KHCO₃ solution is passed into the absorption chamber 5 and the desorption chamber 4 that are separated by the bipolar membrane 2, the K₄[Fe(CN)₆] solution is passed into the anode reaction chamber 14, and the K₃[Fe(CN)₆] solution is passed into the cathode reaction chamber 13. Air is introduced into the absorption chamber 5. The power source 8 is turned on, and a current density is controlled to be 10 mA/cm². CO₂ in the air reacts with OH⁻ from the bipolar membrane 2 to generate HCO₃⁻, which reaches a charge balance with K⁺ from the anode reaction chamber 14. The KHCO₃ solution is passed into the desorption chamber 4 through the first pipeline 9, and reacts with H⁺ from the bipolar membrane 2 to generate CO₂, H₂O and K⁺, where K⁺ moves to the cathode reaction chamber 13 through the first cation exchange membrane 1, and CO₂ separates from the solution and is captured at an outlet. The KHCO₃ solution is restored to the initial concentration in the absorption chamber 5 and sent back to the absorption chamber 5 through the second pipeline 10. A reduction reaction occurs in the cathode reaction chamber 13, where the K₃[Fe(CN)₆] solution gains an electron and is reduced to the K₄[Fe(CN)₆] solution. An oxidation reaction occurs in the anode reaction chamber 14, where the K₄[Fe(CN)₆] solution loses an electron and is oxidized into the K₃[Fe(CN)₆] solution. The K₃[Fe(CN)₆] solution is delivered to the cathode reaction chamber 13 through the third pipeline 11, and the K₄[Fe(CN)₆] solution is delivered to the anode reaction chamber 14 through the fourth pipeline 12. Repeating in this way, K⁺ in the cathode reaction chamber 13 is continuously sent to the anode reaction chamber 14 to maintain an ion balance in the system.

The various examples in this specification are described in a progressive manner. For each example, the difference from other examples is focused on, and the same and similar parts between the various examples may be referred to each other.

In this specification, specific examples are used to explain the principle and implementation of the present disclosure, and the explanations of the above examples are only used to help understand the method and core ideas of the present disclosure. At the same time, according to the concept of the present disclosure, modifications may be made in the specific implementation and application scope for those ordinary skilled in this field. To sum up, the content of this specification should not be construed as a limitation of the present disclosure.

What is claimed is:

1. A system for capturing carbon from air based on bipolar membrane electrodialysis, comprising a first cation exchange membrane, a bipolar membrane and a second cation exchange membrane arranged in sequence,
wherein a desorption chamber is arranged between the first cation exchange membrane and the bipolar membrane, and an absorption chamber is arranged between the bipolar membrane and the second cation exchange membrane; and
a cathode reaction chamber is arranged on the other side of the first cation exchange membrane, and an anode reaction chamber is arranged on the other side of the second cation exchange membrane.

2. The system according to claim 1, wherein one end of the desorption chamber and one end of the absorption chamber are connected by a first pipeline;
the other end of the desorption chamber and the other end of the absorption chamber are connected by a second pipeline; and
a bicarbonate solution is passed into the desorption chamber and the absorption chamber, respectively.

3. The system according to claim 1, wherein one end of the cathode reaction chamber and one end of the anode reaction chamber are connected by a third pipeline;
the other end of the cathode reaction chamber and the other end of the anode reaction chamber are connected by a fourth pipeline;
a to-be-reduced solution is passed into the cathode reaction chamber, and a to-be-oxidized solution is passed into the anode reaction chamber; and
the to-be-reduced solution and the to-be-oxidized solution form a redox pair.

4. The system according to claim 1, further comprising a first electrode, a second electrode and a power source,
wherein the first electrode is arranged in the cathode reaction chamber and connected to a negative electrode of the power source; and
the second electrode is arranged in the anode reaction chamber and connected to a positive electrode of the power source.

5. The system according to claim 1, wherein the bipolar membrane comprises a cation exchange layer, a reaction layer and an anion exchange layer connected in sequence.

6. The system according to claim 1, wherein the bipolar membrane is any one selected from the group consisting of a BP-1 bipolar membrane and an FBM bipolar membrane.

7. The system according to claim 2, wherein the bicarbonate solution is a KHCO₃ solution.

8. The system according to claim 3, wherein the to-be-reduced solution is a K₃[Fe(CN)₆] solution, and the to-be-oxidized solution is a K₄[Fe(CN)₆] solution.

9. The system according to claim 4, wherein the first electrode and the second electrode are each any one selected from the group consisting of Pt, Au, Pd, Ru, Ir, Rh, Re, Os, Cu, Ag, Fe, Co, Ni, Zn and C or a combination thereof.
